(19) United States
(12) Patent Application Publication
(10) Pub. No.: US 2026/0163306 A1
(43) Pub. Date: Jun. 11, 2026

(54) RECEPTACLE CAGE

(71) Applicant: TE Connectivity Solutions GmbH, Schaffhausen (CH)

(72) Inventors: Richard James Long, Middletown, PA (US); Freddy R Galindo Palomino, Middletown, PA (US); Alex Michael Sharf, Middletown, PA (US)

(21) Appl. No.: 18/977,590

(22) Filed: Dec. 11, 2024

(51) Int. Cl. H01R 13/659; H01R 12/71

(52) U.S. Cl. CPC H01R 13/659; H01R 12/716

(57) ABSTRACT

A receptacle cage for shielding electrical connections between a receptacle connector and a pluggable module is provided. The receptacle cage includes cage walls extending between a front end and a rear end of the receptacle cage. The cage walls include a top wall, a first side wall, a second side wall, and a rear wall forms a cavity. The first and second side walls and the rear wall configured to be mounted to a circuit board. The cavity forms a connector channel configured to receive the receptacle connector. The cavity forms a module channel configured to receive the pluggable module configured to be coupled to the receptacle connector. The first side wall has a first edge configured to be mounted to the circuit board. The second side wall has a second edge configured to be mounted to the circuit board. The rear wall has a rear edge configured to be mounted to the circuit board. The first side wall includes a first EMI fence at the first edge configured to be coupled to the circuit board. The second side wall includes a second EMI fence at the second edge configured to be coupled to the circuit board. The rear wall includes a rear EMI fence at the rear edge configured to be coupled to the circuit board.

### BACKGROUND OF THE INVENTION

The subject matter herein relates generally to receptacle connector assemblies.

Some communication systems utilize receptacle assemblies having communication connectors to interconnect various components of the system for data communication. The receptacle assemblies include receptacle cages that receive pluggable modules, such as I/O modules, that are electrically connected to the communication connector. The receptacle cages provide electrical shielding, such as EMI shielding, for the pluggable modules. Known receptacle cages are not without disadvantages. For instance, openings or gaps in the walls of the receptacle cage provide areas for potential EMI leakage.

A need remains for a receptacle cage having improved EMI shielding.

### BRIEF DESCRIPTION OF THE INVENTION

In one embodiment, a receptacle cage for shielding electrical connections between a receptacle connector and a pluggable module is provided. The receptacle cage includes cage walls extending between a front end and a rear end of the receptacle cage. The cage walls include a top wall, a first side wall, a second side wall, and a rear wall forms a cavity. The first and second side walls and the rear wall configured to be mounted to a circuit board. The cavity forms a connector channel configured to receive the receptacle connector. The cavity forms a module channel configured to receive the pluggable module configured to be coupled to the receptacle connector. The first side wall has a first edge configured to be mounted to the circuit board. The second side wall has a second edge configured to be mounted to the circuit board. The rear wall has a rear edge configured to be mounted to the circuit board. The first side wall includes a first EMI fence at the first edge configured to be coupled to the circuit board. The second side wall includes a second EMI fence at the second edge configured to be coupled to the circuit board. The rear wall includes a rear EMI fence at the rear edge configured to be coupled to the circuit board.

In another embodiment, a receptacle connector assembly is provided and includes a receptacle connector having a mating end configured to be coupled to a pluggable module. The receptacle connector assembly includes a receptacle cage configured to be mounted to the circuit board and surround the receptacle connector for shielding the pluggable module and the receptacle connector. The receptacle cage includes cage walls extending between a front end and a rear end of the receptacle cage. The cage walls include a top wall, a first side wall, a second side wall, and a rear wall forms a cavity. The first and second side walls and the rear wall configured to be mounted to the circuit board. The cavity forms a connector channel receiving the receptacle connector. The cavity forms a module channel forward of the connector channel configured to receive the pluggable module. The first side wall has a first edge configured to be mounted to the circuit board. The second side wall has a second edge configured to be mounted to the circuit board. The rear wall has a rear edge configured to be mounted to the circuit board. The first side wall includes a first EMI fence at the first edge configured to be coupled to the circuit board. The second side wall includes a second EMI fence at the second edge configured to be coupled to the circuit board. The rear wall includes a rear EMI fence at the rear edge configured to be coupled to the circuit board.

In a further embodiment, a communication system is provided and includes a pluggable module that includes an outer housing extending between a mating end and a cable end. The pluggable module includes a module circuit board in the outer housing includes a card edge proximate to the mating end of the outer housing. The communication system includes a receptacle connector assembly configured to be mounted to the circuit board. The receptacle connector assembly includes a receptacle cage and a receptacle connector received in the receptacle cage for electrical connection with the pluggable module. The receptacle cage has cage walls extending between a front end and a rear end of the receptacle cage. The cage walls include a top wall, a first side wall, a second side wall, and a rear wall forms a cavity. The first and second side walls and the rear wall configured to be mounted to the circuit board. The cavity forms a connector channel receiving the receptacle connector. The cavity forms a module channel forward of the connector channel configured to receive the pluggable module. The first side wall has a first edge configured to be mounted to the circuit board. The second side wall has a second edge configured to be mounted to the circuit board. The rear wall has a rear edge configured to be mounted to the circuit board. The first side wall includes a first EMI fence at the first edge configured to be coupled to the circuit board. The second side wall includes a second EMI fence at the second edge configured to be coupled to the circuit board. The rear wall includes a rear EMI fence at the rear edge configured to be coupled to the circuit board.

### BRIEF DESCRIPTION OF THE DRAWINGS

FIG. 1 is a front perspective view of a communication system formed in accordance with an exemplary embodiment.

FIG. 2 is a perspective view of the pluggable 106 in accordance with an exemplary embodiment.

FIG. 3 is a rear perspective view of a portion of the communication system showing the receptacle cage in accordance with an exemplary embodiment.

FIG. 4 is a rear perspective view of a portion of the communication system showing internal portions in the cavity of the receptacle cage in phantom in accordance with an exemplary embodiment.

FIG. 5 is a cross-sectional view of a portion of the receptacle cage showing a portion of the EMI fence in accordance with an exemplary embodiment.

FIG. 6 is a cross-sectional view of a portion of the receptacle cage showing a portion of the EMI fence 200 in accordance with an exemplary embodiment.

FIG. 7 is a perspective view of a portion of the receptacle cage in accordance with an exemplary embodiment.

### DETAILED DESCRIPTION OF THE INVENTION

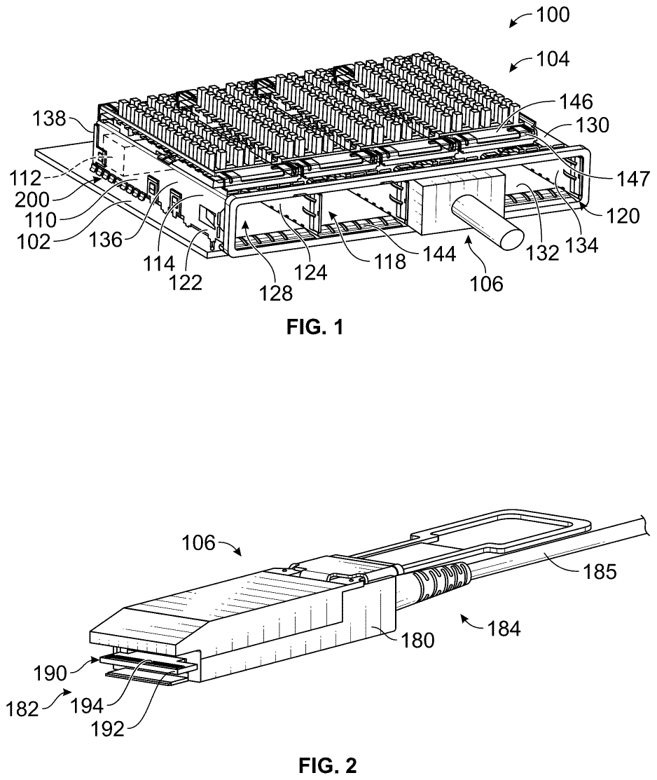

FIG. 1 is a front perspective view of a communication system 100 formed in accordance with an exemplary embodiment. The communication system 100 includes a circuit board 102 and a receptacle connector assembly 104 mounted to the circuit board 102. Pluggable modules 106 are configured to be electrically connected to the receptacle connector assembly 104. The pluggable modules 106 are electrically connected to the circuit board 102 through the receptacle connector assembly 104.

In an exemplary embodiment, the receptacle connector assembly 104 includes a receptacle cage 110 and one or more receptacle connectors 112 (shown in phantom) received in the receptacle cage 110. The receptacle cage 110 surrounds the receptacle connector(s) 112 and provides electrical shielding for the receptacle connector 112. The receptacle connector 112 may be mounted to the circuit board 102 (for example, mechanically and/or electrically connected to the circuit board 102). In other various embodiments, the receptacle connector 112 may be an over-the-board connector having cables extending from the receptacle connector 112 that are terminated to another component or terminated to the circuit board 102 at a location remote from the circuit board rather than directly connecting the receptacle connector 112 to the circuit board 102. In various embodiments, the receptacle connector 112 is a card edge connector having receptacle contacts arranged along a card slot for electrical connection with the corresponding pluggable module 106. The pluggable modules 106 are loaded into the receptacle cage 110 and are at least partially surrounded by the receptacle cage 110.

The receptacle cage 110 includes a plurality of cage walls 114 forming a cavity 128 that is divided into a plurality of module channels 118. Each module channel 118 receives a corresponding pluggable module 106. The cage walls 114 may be solid walls or may be perforated walls (for example, with small openings) to allow airflow therethrough. The cage walls 114 may have cutouts for a heatsink or heat spreader. In an exemplary embodiment, the cage walls 114 are stamped and formed metallic walls that provide shielding for the pluggable modules 106 and the receptacle connectors 112.

In the illustrated embodiment, the receptacle cage 110 includes a single row of module channels 118. However, in alternative embodiments, the receptacle cage may include multiple rows of module channels 118, such as stacked module channels 118 including upper and lower module channels. The receptacle cage 110 has module ports 120 that open to the module channels 118. The pluggable modules 106 are plugged into the module channels 118 through the module ports 120. Any number of module channels 118 may be provided in various embodiments. In the illustrated embodiment, the receptacle cage 110 includes four module channels 118 ganged together and arranged in a single row (4×1). In other embodiments, greater or fewer module channels 118 may be provided, such as 2×1, 3×1, 8×1, and the like. In other embodiments, the module channels 118 may be stacked, such as 2×2, 3×2, 4×2, 4×3, and the like. Optionally, multiple receptacle connectors 112 may be arranged within the receptacle cage 110, such as one within each module channel 118.

In an exemplary embodiment, the cage walls 114 of the receptacle cage 110 include exterior walls 122 and one or more interior walls 124. The exterior walls 122 form the cavity 128. The interior wall(s) 124 are located in the cavity 128 and divide the cavity 128 into the module channels 118. The interior wall(s) 124 separate the module channels 118 from each other and provide electrical shielding between the module channels 118 on either side of the interior wall 124. The exterior walls 122 provide external shielding for the module channels 118.

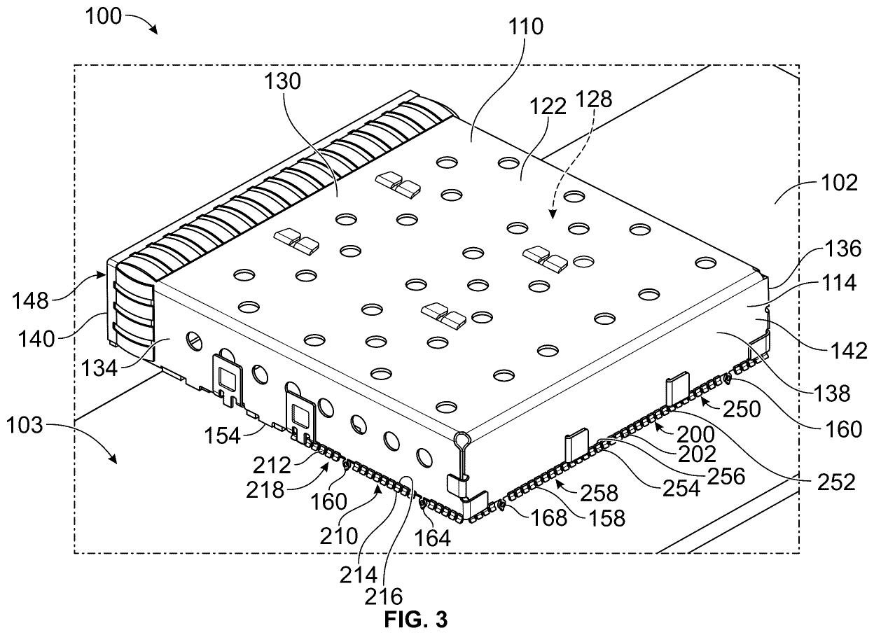

The exterior walls 122 include, as further illustrated in FIG. 3, a top wall 130, a bottom wall 132, a first side wall 134, a second side wall 136, and a rear wall 138. The first and second side walls 134, 136 extend between the top wall 130 and the bottom wall 132. The bottom wall 132 may rest on the circuit board 102. However, in alternative embodiments, the bottom wall 132 may be elevated a distance above the circuit board 102 defining a gap below the bottom wall 132, such as for airflow. In other various embodiments, the receptacle cage 110 may be provided without the bottom wall 132 (FIG. 1), rather using a ground plane of the circuit board 102 to provide shielding across the bottom of the receptacle cage 110. The top wall 130, the bottom wall 132, the side walls 134, 136, and the rear wall 138 define the cavity 128. The top wall 130, the bottom wall 132, the side walls 134, 136, and the rear wall 138 define the exterior of the receptacle cage 110.

In an exemplary embodiment, the rear wall 138 and the side walls 134, 136 include EMI fences 200 at the bottom of the receptacle cage 110. The EMI fences 200 may be located in the proximity of the receptacle connector 112, such as around the opening in the bottom of the receptacle cage 110 through which the receptacle connector 112 passes. The EMI fences 200 provide an electrical connection to a ground plane of the circuit board 102. The EMI fences 200 seal the receptacle cage 110 electrically to the circuit board 102 to prevent energy from leaking through the space between the receptacle cage 110 and the circuit board 102. The bottom wall 132 may additionally include an EMI fence 200. The interior walls 124 may additionally include EMI fences 200.

The cage walls 114 extend between a front end 140 and a rear end 142 of the receptacle cage 110. The module ports 120 are provided at the front end 140. The rear wall 138 is provided at the rear end 142. In various embodiments, a gasket 144 is provided at the front end 140, such as at the module ports 120. The gasket 144 may extend into the module channels 118 to interface with the pluggable modules 106. The gasket 144 may be configured to electrically connect to a panel or bezel.

In an exemplary embodiment, the interior walls 124 extend between the front end 140 and the rear end 142. In the illustrated embodiment, the interior walls 124 are oriented vertically. For example, the interior walls 124 are parallel to the side walls 134, 136. The interior walls 124 extend between the top wall 130 and the bottom wall 132. In an exemplary embodiment, the interior walls 124 are connected to the top wall 130, the bottom wall 132, and the rear wall 138. In various embodiments, other interior walls 124 may separate or divide the cavity 128 into upper and lower module channels 118. For example, the interior walls 124 may form a channel separator forming a space between the upper and lower module channels 118, such as for airflow, for a heat sink, for routing light pipes, or for other purposes.

In an exemplary embodiment, the receptacle connector assembly 104 may include one or more heat sinks 146 for dissipating heat from the pluggable modules 106. For example, the heat sinks 146 may be coupled to the top wall 130 for engaging the upper surfaces of the pluggable modules 106. The heat sinks 146 may extend through openings in the top wall 130 to directly engage the pluggable modules 106. Hold-down clips 147 may be used to secure the heat sinks 146 to the receptacle cage 110. Other types of heat sinks may be provided in alternative embodiments.

FIG. 2 is a perspective view of the pluggable module 106 in accordance with an exemplary embodiment. The pluggable module 106 has a pluggable body 180, which may be defined by one or more shells. The pluggable body 180 may be thermally conductive and/or may be electrically conductive, such as to provide EMI shielding for the pluggable module 106. The pluggable body 180 includes a mating end 182 and an opposite cable end 184. The mating end 182 is configured to be inserted into the corresponding module channel 118 (shown in FIG. 1). A cable 185 extends from the cable end 184 to another component within the system.

The pluggable module 106 includes a module circuit board 190 that is configured to be communicatively coupled to the receptacle connector 112 (shown in FIG. 1). For example, the module circuit board 190 may be plugged into the card slot of the receptacle connector 112. The module circuit board 190 is accessible at the mating end 182. The module circuit board 190 has a card edge 192 extending between a first or upper surface and a second or lower surface at a mating end of the module circuit board 190. The module circuit board 190 includes mating contacts 194, such as pads or circuits, at the card edge 192 configured to be mated with the receptacle connector 112. In an exemplary embodiment, the mating contacts 194 are provided on the upper surface and the lower surface. The module circuit board 190 may include components, circuits and the like used for operating and or using the pluggable module 106. For example, the module circuit board 190 may have conductors, traces, pads, electronics, sensors, controllers, switches, inputs, outputs, and the like associated with the module circuit board 190, which may be mounted to the module circuit board 190, to form various circuits.

In other various embodiments, the pluggable module 106 may be a circuit card rather than an I/O module. For example, the pluggable module 106 may include the module circuit board 190 without the pluggable body 180 surrounding the module circuit board 190.

In an exemplary embodiment, the pluggable body 180 provides heat transfer for the module circuit board 190, such as for the electronic components on the module circuit board 190. For example, the module circuit board 190 is in thermal communication with the pluggable body 180 and the pluggable body 180 transfers heat from the module circuit board 190. In various embodiments, the pluggable body 180 may include heat transfer fins (not shown) along at least a portion of the outer perimeter of the pluggable module 106 to transfer heat away from the main shell of the pluggable body 180, and thus from the module circuit board 190 and associated components. The fins are separated by gaps that allow airflow or other cooling flow along the surfaces of the fins to dissipate the heat therefrom.

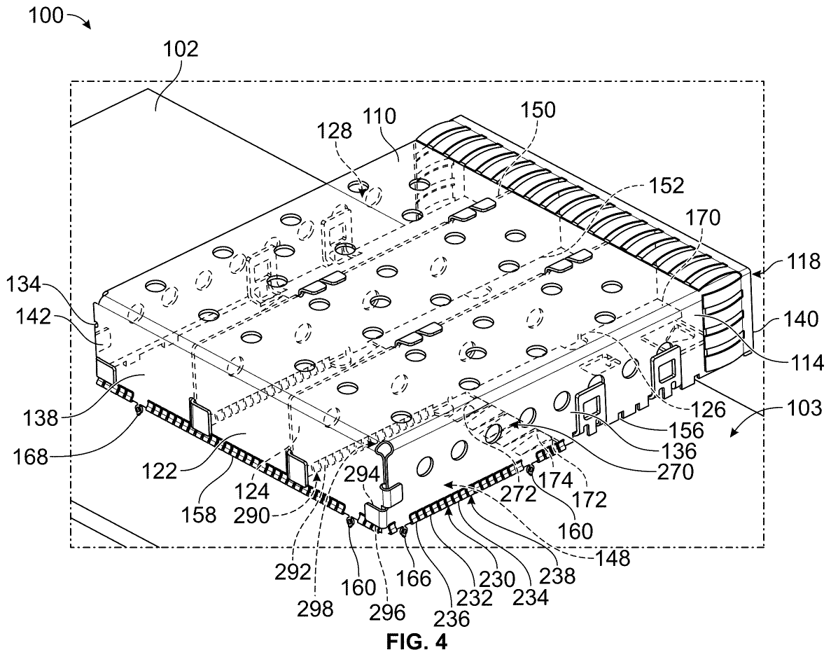

FIG. 3 is a rear perspective view of a portion of the communication system 100 showing the receptacle cage 110 in accordance with an exemplary embodiment. FIG. 4 is a rear perspective view of a portion of the communication system 100 showing internal portions in the cavity 128 of the receptacle cage 110 in phantom in accordance with an exemplary embodiment.

The receptacle cage 110 includes the cage walls 114 extending between the front end 140 and the rear end 142. The cage walls 114 include the exterior walls 122 and the interior walls 124 (FIG. 4). The exterior walls 122 surround and form the cavity 128. The interior walls 124 are received in the cavity 128 and divides the cavity 128 into different module channels 118 on opposite sides of the interior walls 124. The exterior walls 122 provide external shielding for the module channels 118. The interior wall 124 provides shielding between the different module channels 118.

The exterior walls 122 include the top wall 130, the bottom wall 132, the side walls 134, 136, and the rear wall 138. Optionally, some or all of the exterior walls 122 may be integral with each other. For example, in the illustrated embodiment, the top wall 130 is integral with the side walls 134, 136 and the rear wall 138. The bottom wall 132 may be separate and discrete from the other walls and coupled thereto to form the receptacle cage 110. However, the bottom wall 132 may be integral with the other walls, such as extending from the side wall 134. The top and bottom walls 130, 132 extend between the side walls 134, 136.

In an exemplary embodiment, the bottom wall 132 does not extend the entire length of the receptacle cage 110. For example, the bottom wall 132 stops short of the rear wall 138 such that an opening 148 (FIG. 4) is rearward of the bottom wall 132. The opening 148 is located between the bottom wall 132 and the rear wall 138. The receptacle connector 112 (shown in FIG. 1) is loaded into the cavity 128 through the opening 148. In other embodiments, the bottom wall 132 may extend to the rear wall 138 and include the opening through the bottom wall 132. For example, the bottom wall 132 does not stop at the opening 148 but rather surrounds the opening 148 along the sides and may extend along the rear of the opening 148. The rear wall 138 extends between the first and second side walls 134, 136. The rear wall 138 extends between the top wall 130 and the circuit board 102 at the bottom of the receptacle cage 110. In other various embodiments, the receptacle connector 112 may pass through the rear wall 138. For example, the housing of the receptacle connector 112 and/or cables extending from the receptacle connector 112 may pass through the rear wall 138.

The interior wall 124 extends between the top wall 130 and the bottom wall 132. The interior wall 124 extends between the front end 140 and the rear end 142 of the receptacle cage 110. For example, the interior wall 124 may extend across the opening 148 between the rear of the bottom wall 132 and the rear wall 138. In an exemplary embodiment, the interior wall 124 is planar and parallel to the side walls 134, 136. The interior wall 124 is positioned in the cavity 128 to face the exterior walls 122. The interior wall 124 includes an upper edge 150 and a lower edge 152 opposite the upper edge 150. The upper edge 150 faces the top wall 130 and interfaces with the top wall 130. The lower edge 152 faces the bottom wall 132 and interfaces with the bottom wall 132.

The receptacle cage 110 is mounted to the circuit board 102. For example, the bottom of the receptacle cage 110 is mounted to the top surface of the circuit board 102. The receptacle cage 110 is electrically connected to the circuit board 102, such as to a ground plane of the circuit board 102. In an exemplary embodiment, the receptacle cage 110 is coupled to the circuit board 102, such as using compliant pins 160, such as press-fit pins. In alternative embodiments, the receptacle cage 110 may be coupled to the circuit board 102 using solder tabs soldered to pads on the circuit board 102. The receptacle cage 110 may be secured to the circuit board using clips, latches, fasteners, or other mounting means.

In an exemplary embodiment, the first side wall 134 includes a first edge 154 at the bottom of the first side wall 134, the second side wall 136 includes a second edge 156 at the bottom of the second side wall 136, and the rear wall 138 includes a rear edge 158 at the bottom of the rear wall 138. The first edge 154 is configured to be mounted to the circuit board 102, such as using corresponding compliant pins 160. The second edge 156 is configured to be mounted to the circuit board 102, such as using corresponding compliant pins 160. The rear edge 158 is configured to be mounted to the circuit board 102, such as using corresponding compliant pins 160. The compliant pins 160 form mechanical and electrical connection to the circuit board 102. In an exemplary embodiment, the EMI fences 200, at the bottom of the receptacle cage 110, provide an electrical connection to the circuit board 102, such as to a ground plane at the top surface of the circuit board 102. The EMI fences 200 seal the receptacle cage 110 electrically to the circuit board 102 to prevent energy from leaking through the space between the bottom edges 154, 156, 158 of the exterior walls 122 of the receptacle cage 110 and the circuit board 102.

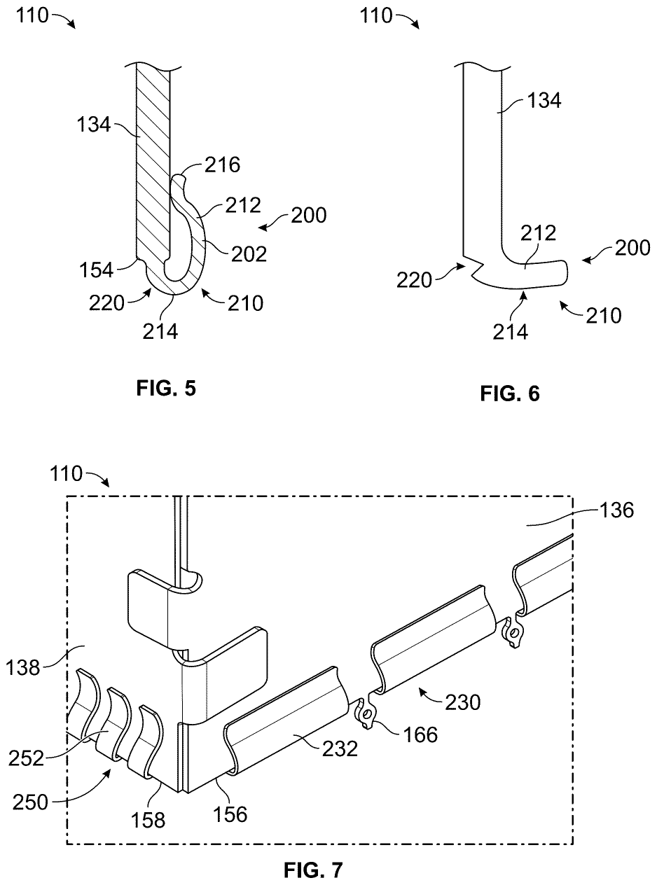

With additional reference to FIG. 5, which is a cross-sectional view of a portion of the receptacle cage 110 showing a portion of the EMI fence 200 in accordance with an exemplary embodiment, the EMI fence 200 includes spring tabs 202 configured to interface with the circuit board 102. The spring tabs 202 are configured to be electrically connected to a ground plane 103 of the circuit board 102. The spring tabs 202 seal the receptacle cage 110 electrically to the circuit board 102 to prevent energy from leaking through the space between the bottom of the receptacle cage 110 and the circuit board 102. While FIG. 5 shows the EMI fence 200 associated with the side wall 134, it is realized that the EMI fences of the second side wall 136 and/or the rear wall 138 and/or the interior walls 124 and/or the bottom wall 138 may include similar or identical features, such as shown in FIGS. 3 and 4.

In an exemplary embodiment, the first side wall 134 including a first EMI fence 210 at the first edge 154 configured to be coupled to the circuit board 102. The first EMI fence 210 is integral with the first side wall 134. For example, the first EMI fence 210 is stamped and formed with the first side wall 134 as a unitary structure. In an exemplary embodiment, the second side wall 136 includes a second EMI fence 230 at the second edge 156 configured to be coupled to the circuit board 102. The second EMI fence 230 is integral with the second side wall 136. For example, the second EMI fence 230 is stamped and formed with the second side wall 136 as a unitary structure. In an exemplary embodiment, the rear wall 138 includes a rear EMI fence 250 at the rear edge 158 configured to be coupled to the circuit board 102. In an exemplary embodiment, the rear wall 138 includes a rear EMI fence 250 at the rear edge 158 configured to be coupled to the circuit board 102. The rear EMI fence 250 is integral with the rear wall 138. For example, the rear EMI fence 250 is stamped and formed with the rear wall 138 as a unitary structure. In an exemplary embodiment, the first side wall 134, the second side wall 136 and the rear wall 138 are stamped and formed from a single sheet of sheet metal. The top wall 130 and/or the bottom wall 132 may be stamped and formed, with the first side wall 134, the second side wall 136 and the rear wall 138, from the single sheet of sheet metal.

In an exemplary embodiment, the first EMI fence 210 includes first spring tabs 212. The first spring tabs 212 extend from the first edge 154. The first spring tabs 212 are stamped and formed with the first side wall 134. The first spring tabs 212 may be bent or folded, such as outward or inward into the cavity 128. The first spring tabs 212 are compressible against the top surface of the circuit board 102. For example, the first spring tabs 212 are folded outward to form compressible mating interfaces 214 with the circuit board 102. In an exemplary embodiment, the first spring tabs 212 include distal ends 216 engaging the first side wall 134. In an exemplary embodiment, the first EMI fence 210 includes a plurality of the first spring tabs 212 arranged in a row along the first edge 154. The first spring tabs 212 are separated by gaps 218. The first spring tabs 212 are independently movable relative to each other, such as to allow the first EMI fence 210 to conform to the top surface of the circuit board 102.

In an exemplary embodiment, the first spring tabs 212 may be thinned to allow forming. For example, the first spring tabs 212 may be thinned to allow bending of the first spring tabs 212 at a tight radius to form the mating interfaces 214. In an exemplary embodiment, the first spring tabs 212 include necks 220 at the first side wall 134. In various embodiments, the neck 220 may have a reduced width compared to the first spring tab 212 (e.g., as shown in FIG. 6) to reduce a cross-sectional area of the first spring tab 212 and allow bending at a tight radius. In various embodiments, the neck 220 may have a reduced thickness compared to the first side wall 134 to reduce a cross-sectional area of the first spring tab 212 and allow bending at a tight radius. The first spring tab 212 may be coined, machined, sheared, cut or otherwise processed to reduce one or more dimensions of the first spring tab 212, particularly at the area of forming, to allow bending at a tight radius.

In an exemplary embodiment, the first side wall 134 includes first compliant pins 164 interspersed with the first EMI fence 210 at the first edge 154. For example, the first compliant pins 164 are interspersed with the first spring tabs 212. For example, one or more first spring tabs 212 may be located between the first compliant pins 164. The first compliant pins 164 are configured to be press fit into vias of the circuit board 102 to mechanically and electrically connect the first side wall 134 to the circuit board 102. The first compliant pins 164 may be integral with the first side wall 134, such as being stamped and formed with the first side wall 134, as a unitary structure. The first compliant pins 164 and the first spring tabs 212 are both stamped from the same sheet of metal, such as with the first side wall 134.

In an exemplary embodiment, the second EMI fence 230 includes second spring tabs 232. The second spring tabs 232 extend from the second edge 156. The second spring tabs 232 are stamped and formed with the second side wall 136. The second spring tabs 232 may be bent or folded outward or inward into the cavity 128. The second spring tabs 232 are compressible against the top surface of the circuit board 102. For example, the second spring tabs 232 are folded outward to form compressible mating interfaces 234 with the circuit board 102. In an exemplary embodiment, the second spring tabs 232 include distal ends 236 engaging the second side wall 136. In an exemplary embodiment, the second EMI fence 230 includes a plurality of the second spring tabs 232 arranged in a row along the second edge 156. The second spring tabs 232 are separated by gaps 238. The second spring tabs 232 are independently movable relative to each other, such as to allow the second EMI fence 230 to conform to the top surface of the circuit board 102.

In an exemplary embodiment, the second spring tabs 232 may be thinned to allow forming. For example, the second spring tabs 232 may be thinned to allow bending of the second spring tabs 232 at a tight radius to form the mating interfaces 234. In an exemplary embodiment, the second spring tabs 232 include necks 240 at the second side wall 136. In various embodiments, the neck 240 may have a reduced width compared to the second spring tab 232 to reduce a cross-sectional area of the second spring tab 232 and allow bending at a tight radius. In various embodiments, the neck 240 may have a reduced thickness compared to the second side wall 136 to reduce a cross-sectional area of the second spring tab 232 and allow bending at a tight radius. The second spring tab 232 may be coined, machined, sheared, cut or otherwise processed to reduce one or more dimensions of the second spring tab 232, particularly at the area of forming, to allow bending at a tight radius.

In an exemplary embodiment, the second side wall 136 includes second compliant pins 166 interspersed with the second EMI fence 230 at the second edge 156. For example, the second compliant pins 166 are interspersed with the second spring tabs 232. For example, one or more second spring tabs 232 may be located between the second compliant pins 166. The second compliant pins 166 are configured to be press fit into vias of the circuit board 102 to mechanically and electrically connect the second side wall 136 to the circuit board 102. The second compliant pins 166 may be integral with the second side wall 136, such as being stamped and formed with the second side wall 136, as a unitary structure. The second compliant pins 166 and the second spring tabs 232 are both stamped from the same sheet of metal, such as with the second side wall 136.

In an exemplary embodiment, the rear EMI fence 250 includes rear spring tabs 252. The rear spring tabs 252 extend from the rear edge 158. The rear spring tabs 252 are stamped and formed with the rear wall 138. The rear spring tabs 252 may be bent or folded outward or inward into the cavity 128. The rear spring tabs 252 are compressible against the top surface of the circuit board 102. For example, the rear spring tabs 252 are folded outward to form compressible mating interfaces 254 with the circuit board 102. In an exemplary embodiment, the rear spring tabs 252 include distal ends 256 engaging the rear wall 138. In an exemplary embodiment, the rear EMI fence 250 includes a plurality of the rear spring tabs 252 arranged in a row along the rear edge 158. The rear spring tabs 252 are separated by gaps 258. The rear spring tabs 252 are independently movable relative to each other, such as to allow the rear EMI fence 250 to conform to the top surface of the circuit board 102.

In an exemplary embodiment, the rear spring tabs 252 may be thinned to allow forming. For example, the rear spring tabs 252 may be thinned to allow bending of the rear spring tabs 252 at a tight radius to form the mating interfaces 254. In an exemplary embodiment, the rear spring tabs 252 include necks 240 at the rear wall 138. In various embodiments, the neck 240 may have a reduced width compared to the rear spring tab 252 to reduce a cross-sectional area of the rear spring tab 252 and allow bending at a tight radius. In various embodiments, the neck 240 may have a reduced thickness compared to the rear wall 138 to reduce a cross-sectional area of the rear spring tab 252 and allow bending at a tight radius. The rear spring tab 252 may be coined, machined, sheared, cut or otherwise processed to reduce one or more dimensions of the rear spring tab 252, particularly at the area of forming, to allow bending at a tight radius.

In an exemplary embodiment, the rear wall 138 includes rear compliant pins 168 interspersed with the rear EMI fence 250 at the rear edge 158. For example, the rear compliant pins 168 are interspersed with the rear spring tabs 252. For example, one or more rear spring tabs 252 may be located between the rear compliant pins 168. The rear compliant pins 168 are configured to be press fit into vias of the circuit board 102 to mechanically and electrically connect the rear wall 138 to the circuit board 102. The rear compliant pins 168 may be integral with the rear wall 138, such as being stamped and formed with the rear wall 138, as a unitary structure. The rear compliant pins 168 and the rear spring tabs 252 are both stamped from the same sheet of metal, such as with the rear wall 138.

In an exemplary embodiment, the bottom wall 132 extends between a front 170 and a rear 172. The opening 148 is defined rearward of the bottom wall 132, such as between the rear 172 of the bottom wall 132 and the rear wall 138. For example, the rear 172 has a bottom edge 174 facing the opening 148. The opening 148 is configured to receive the receptacle connector 112 between the rear 172 of the bottom wall 132 and the rear wall 138. In an exemplary embodiment, the first EMI fence 210, the second EMI fence 230, and the rear EMI fence 250 surround three sides of the opening 148. The EMI fences 210, 230, 250 seal the receptacle cage 110 electrically to the circuit board 102 to prevent energy from leaking through the space between the bottom edges 154, 156, 158 and the circuit board 102.

In an exemplary embodiment, the bottom wall 132 includes a bottom EMI fence 270 at the rear 172 of the bottom wall 132. The bottom EMI fence 270 extends along the fourth side (for example, front) of the opening 148. The bottom EMI fence 270 includes bottom spring tabs 272. The bottom spring tabs 272 extend from the bottom edge 174 into the opening 148. The bottom spring tabs 272 are stamped and formed with the bottom wall 132. The bottom spring tabs 272 are compressible against the top surface of the circuit board 102. In an exemplary embodiment, the bottom EMI fence 270 includes a plurality of the bottom spring tabs 272 arranged in a row along the bottom edge 174 separated by gaps. The bottom spring tabs 272 are independently movable relative to each other.

In an exemplary embodiment, the interior wall 124 includes an interior edge 126 at the bottom of the interior wall 124. The interior edge 126 faces the opening 148. In an exemplary embodiment, the interior wall 124 including a first EMI fence 290 at the interior edge 126 configured to be coupled to the circuit board 102. The first EMI fence 290 is integral with the interior wall 124. For example, the first EMI fence 290 is stamped and formed with the interior wall 124 as a unitary structure.

In an exemplary embodiment, the first EMI fence 290 includes first spring tabs 292. The first spring tabs 292 extend from the interior edge 126. The first spring tabs 292 are stamped and formed with the interior wall 124. The first spring tabs 292 may be bent or folded, such as to one side or the other of the interior wall 124. The first spring tabs 292 are compressible against the top surface of the circuit board 102. For example, the first spring tabs 292 are folded outward to form compressible mating interfaces 294 with the circuit board 102. In an exemplary embodiment, the first spring tabs 292 include distal ends 296 engaging the interior wall 124. In an exemplary embodiment, the first EMI fence 290 includes a plurality of the first spring tabs 292 arranged in a row along the interior edge 126. The first spring tabs 292 are separated by gaps 298. The first spring tabs 292 are independently movable relative to each other, such as to allow the first EMI fence 290 to conform to the top surface of the circuit board 102. In an exemplary embodiment, the first spring tabs 292 may be thinned to allow forming. For example, the first spring tabs 292 may be thinned to allow bending of the first spring tabs 292 at a tight radius to form the mating interfaces 294.

FIG. 6 is a cross-sectional view of a portion of the receptacle cage 110 showing a portion of the EMI fence 200 in accordance with an exemplary embodiment. FIG. 6 shows the first EMI fence 210 and the first side wall 134. In the illustrated embodiment, the neck 220 is thinned in the thickness dimension. For example, the neck 220 is formed by cutting into the thickness of the first spring tab 212 to allow bending of the first spring tab 212 at a tight radius to form the mating interfaces 214. In the illustrated embodiment, the first spring tab 212 is bent at an angle relative to the first side wall 134, such as approximately 90°. The first spring tab 212 may be angled slightly downward toward the circuit board 102 to interface with the circuit board during assembly allowing compression and engagement with the circuit board 102 during assembly.

FIG. 7 is a perspective view of a portion of the receptacle cage 110 in accordance with an exemplary embodiment. FIG. 7 shows the second side wall 136 and the rear wall 138. The second side wall 136 includes the second EMI fence 230 at the second edge 156 and the rear wall 138 includes the rear EMI fence 250 at the rear edge 158. The second EMI fence 230 includes the second spring tabs 232 integral with the second side wall 136, such as being stamped and formed with the second side wall 136 as a unitary structure. The rear EMI fence 250 includes the rear spring tabs 252 integral with the rear wall 138, such as being stamped and formed with the rear wall 138 as a unitary structure.

In an exemplary embodiment, the second spring tabs 232 and the rear spring tabs 252 may have different lengths. For example, the second spring tabs 232 may be elongated compared to the rear spring tabs 252. In the illustrated embodiment, the second spring tabs 232 are elongated between the compliant pins 166 (for example, a single second spring tab between the complaint pins rather than multiple spring tabs with gaps therebetween). In alternative embodiments, the rear spring tabs 252 may additionally or alternatively be elongated as a single spring tab between compliant pins rather than multiple spring tabs separated by gaps.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A receptacle cage for shielding electrical connections between a receptacle connector and a pluggable module, the receptacle cage comprising:
cage walls extending between a front end and a rear end of the receptacle cage, the cage walls including a top wall, a first side wall, a second side wall, and a rear wall forming a cavity, the first and second side walls and the rear wall configured to be mounted to a circuit board;
the cavity forming a connector channel configured to receive the receptacle connector;
the cavity forming a module channel configured to receive the pluggable module configured to be coupled to the receptacle connector;
the first side wall having a first edge configured to be mounted to the circuit board, the second side wall having a second edge configured to be mounted to the circuit board, the rear wall having a rear edge configured to be mounted to the circuit board;
the first side wall including a first EMI fence at the first edge configured to be coupled to the circuit board, the second side wall including a second EMI fence at the second edge configured to be coupled to the circuit board, the rear wall including a rear EMI fence at the rear edge configured to be coupled to the circuit board.

2. The receptacle cage of claim 1, wherein the first EMI fence is integral with the first side wall, the second EMI fence being integral with the second side wall, the rear EMI fence being integral with the rear wall.

3. The receptacle cage of claim 1, wherein the first EMI fence is stamped with the first side wall as a unitary structure, the second EMI fence being stamped with the second side wall as a unitary structure, the rear EMI fence being stamped with the rear wall as a unitary structure.

4. The receptacle cage of claim 1, wherein the first side wall, the second side wall, the top wall and the rear wall being stamped and formed from a single sheet of sheet metal, and wherein the first EMI fence is stamped with the first side wall, the second EMI fence is stamped with the second side wall, and the rear EMI fence is stamped with the rear wall as part of the single sheet of sheet metal.

5. The receptacle cage of claim 1, wherein the first EMI fence includes first spring tabs being compressible against a surface of the circuit board, the second EMI fence including second spring tabs being compressible against the surface of the circuit board, the rear EMI fence including rear spring tabs being compressible against the surface of the circuit board.

6. The receptacle cage of claim 5, wherein the first spring tabs are folded outward to form compressible mating interfaces with the circuit board, the second spring tabs being folded outward to form compressible mating interfaces with the circuit board, the rear spring tabs being folded outward to form compressible mating interfaces with the circuit board.

7. The receptacle cage of claim 5, wherein the first spring tabs include distal ends engaging the first side wall, the second spring tabs including distal ends engaging the second side wall, the rear spring tabs including distal ends engaging the rear wall.

8. The receptacle cage of claim 5, wherein the first spring tabs include necks at the first side wall thinner than a thickness of the first side wall, the second spring tabs including necks at the second side wall thinner than a thickness of the second side wall, the rear spring tabs including necks at the rear wall thinner than a thickness of the rear wall.

9. The receptacle cage of claim 1, wherein the first side wall includes first compliant pins interspersed with the first EMI fence at the first edge configured to be press fit into vias of the circuit board, the second side wall including second compliant pins interspersed with the second EMI fence at the second edge configured to be press fit into vias of the circuit board, the rear wall including rear compliant pins interspersed with the rear EMI fence at the rear edge configured to be press fit into vias of the circuit board.

10. The receptacle cage of claim 1, wherein a bottom wall extends between a front and a rear, an opening being defined rearward of the bottom wall between the rear of the bottom wall and the rear wall, the opening is configured to receive the receptacle connector, wherein the first EMI fence, the second EMI fence, and the rear EMI fence surround three sides of the opening.

11. The receptacle cage of claim 10, wherein the bottom wall includes a bottom EMI fence at the rear of the bottom wall extending along a fourth side of the opening.

12. The receptacle cage of claim 1, wherein the cage walls include an interior wall separating the cavity into the module channel and a second module channel, the interior wall including an interior edge and an interior EMI fence at the interior edge configured to be coupled to the circuit board.

13. A receptacle connector assembly comprising:
a receptacle connector having a mating end configured to be coupled to a pluggable module; and
a receptacle cage configured to be mounted to the circuit board and surround the receptacle connector for shielding the pluggable module and the receptacle connector, the receptacle cage including cage walls extending between a front end and a rear end of the receptacle cage, the cage walls including a top wall, a first side wall, a second side wall, and a rear wall forming a cavity, the first and second side walls and the rear wall configured to be mounted to the circuit board, the cavity forming a connector channel receiving the receptacle connector, the cavity forming a module channel forward of the connector channel configured to receive the pluggable module, the first side wall having a first edge configured to be mounted to the circuit board, the second side wall having a second edge configured to be mounted to the circuit board, the rear wall having a rear edge configured to be mounted to the circuit board, the first side wall including a first EMI fence at the first edge configured to be coupled to the circuit board, the second side wall including a second EMI fence at the second edge configured to be coupled to the circuit board, the rear wall including a rear EMI fence at the rear edge configured to be coupled to the circuit board.

14. The receptacle connector assembly of claim 13, wherein the first EMI fence is integral with the first side wall, the second EMI fence being integral with the second side wall, the rear EMI fence being integral with the rear wall.

15. The receptacle connector assembly of claim 13, wherein the first EMI fence is stamped with the first side wall as a unitary structure, the second EMI fence being stamped with the second side wall as a unitary structure, the rear EMI fence being stamped with the rear wall as a unitary structure.

16. The receptacle connector assembly of claim 13, wherein the first EMI fence includes first spring tabs being compressible against a surface of the circuit board, the second EMI fence including second spring tabs being compressible against the surface of the circuit board, the rear EMI fence including rear spring tabs being compressible against the surface of the circuit board.

17. The receptacle connector assembly of claim 13, wherein the first side wall includes first compliant pins interspersed with the first EMI fence at the first edge configured to be press fit into vias of the circuit board, the second side wall including second compliant pins interspersed with the second EMI fence at the second edge configured to be press fit into vias of the circuit board, the rear wall including rear compliant pins interspersed with the rear EMI fence at the rear edge configured to be press fit into vias of the circuit board.

18. A communication system comprising:
a pluggable modules including an outer housing extending between a mating end and a cable end, the pluggable module including a module circuit board in the outer housing including a card edge proximate to the mating end of the outer housing; and
a receptacle connector assembly configured to be mounted to the circuit board, the receptacle connector assembly including a receptacle cage and a receptacle connector received in the receptacle cage for electrical connection with the pluggable module, the receptacle cage having cage walls extending between a front end and a rear end of the receptacle cage, the cage walls including a top wall, a first side wall, a second side wall, and a rear wall forming a cavity, the first and second side walls and the rear wall configured to be mounted to the circuit board, the cavity forming a connector channel receiving the receptacle connector, the cavity forming a module channel forward of the connector channel configured to receive the pluggable module, the first side wall having a first edge configured to be mounted to the circuit board, the second side wall having a second edge configured to be mounted to the circuit board, the rear wall having a rear edge configured to be mounted to the circuit board, the first side wall including a first EMI fence at the first edge configured to be coupled to the circuit board, the second side wall including a second EMI fence at the second edge configured to be coupled to the circuit board, the rear wall including a rear EMI fence at the rear edge configured to be coupled to the circuit board.

19. The communication system of claim 18, wherein the first EMI fence is integral with the first side wall, the second EMI fence being integral with the second side wall, the rear EMI fence being integral with the rear wall.

20. The communication system of claim 18, wherein the first EMI fence includes first spring tabs being compressible against a surface of the circuit board, the second EMI fence including second spring tabs being compressible against the surface of the circuit board, the rear EMI fence including rear spring tabs being compressible against the surface of the circuit board.
